(19) United States
(12) Patent Application Publication
(10) Pub. No.: US 2010/0192171 A1
(43) Pub. Date: Jul. 29, 2010

(54) Set-Top Box

(76) Inventors: David Dozoretz, Los Angeles, CA (US); Tim Wilcox, Burbank, CA (US); David Daniel Shoop, Grayslake, CA (US); Charles Van Dusen, Beaverton, OR (US)

Correspondence Address: CARR & FERRELL LLP, 2200 GENG ROAD, PALO ALTO, CA, 94303, US

(21) Appl. No.: 12/360,007

(22) Filed: Jan. 26, 2009

(51) Int. Cl. H04N 7/16

(52) U.S. Cl. 725/5; 725/151

(57) ABSTRACT

Various embodiments of a set-top box are described. In some embodiments, a set-top box for controlling a display device includes first circuitry configured to control the display of information on the display device, a housing sized to contain the first circuitry, and one or more adjustable grips attached to the housing. The adjustable grips may be adapted to removably attach the set-top box to the display device. In some cases, a set-top box may be adapted to sit atop a display device having a thickness (in a viewing direction) of less than six, three, two, one, or even 0.5 inches. Some embodiments may be shaped to “hang” on a top surface or edge of a display device. Some embodiments include a set-top box having a feature shaped to hook, latch, or otherwise engage with a display device.

### BACKGROUND

1. Field of Invention

The present invention relates generally to displaying information, and more particularly to set-top boxes configured to operate with display devices.

2. Description of Related Art

Media such as movies, video, television, photographs, and/or songs may be displayed on a display device such as a television set, monitor, screen, or computer display. Many display devices incorporate the use of a set-top box. Typically, the set-top box receives signals associated with the media (e.g., a cable TV signal, a broadcast signal, a digital signal, an IP signal, or other signal) and prepares the signal for display on the monitor. Many set-top boxes receive a plurality of signals (e.g., a plurality of TV stations) and allow a user to choose from among the received signals. Some set-top boxes include decoders or other hardware to translate an incoming signal.

Many set-top boxes have been designed to sit “on top” of a television set, and are named as such. Some set-top boxes have been designed to operate with televisions having a form or shape based on cathode ray tube (CRT) technology. CRT-based display devices typically have a depth that is comparable to the width of the display device, and often include a “top surface” that is large enough to support a typical set-top box. Many display devices have a flat (or modestly sloped) top surface that may be greater than six, ten, or even twenty inches deep.

Some display devices may be described as “thin,” as viewed from above (i.e., thin in a direction parallel to the viewing direction). Thin display devices may not have particularly deep and/or flat top surfaces. Examples include flat panel displays (FPD) such as plasma displays, and liquid crystal displays (LCD). Furthermore, monitors based on organic light emitting diodes (OLED) may be thin when viewed from above. Some projection monitors may be thin when viewed from above, particularly when identifying a region that might be “flat enough” to support a typical set-top box. Additionally, many monitors do not have a “top surface” that is particularly flat, and some monitors do not have a top flat surface that is deep enough to support a typical set top box. As a result, typical “set-top” boxes may not easily be made to “sit” on top of a modern display device.

In some situations, a monitor may be suspended or “hung” from a mounting bracket, and it may be convenient to attach a set-top box to a lower surface of the monitor. Such an attachment may require removably holding the monitor with sufficient force that the set-top box is stably attached.

### SUMMARY OF THE INVENTION

Various embodiments of a set-top box are described. In some embodiments, a set-top box for controlling a display device includes first circuitry configured to control the display of information on the display device, a housing sized to contain the first circuitry, and one or more adjustable grips attached to the housing. The adjustable grips may be adapted to removably attach the set-top box to the display device. In some cases, a set-top box may be adapted to sit atop a display device having a thickness (in a viewing direction) of less than six, three, two, one, or even 0.5 inches.

In some embodiments, the set-top box is configured to initiate or perform a financial transaction associated with displayed media.

Certain embodiments include a set-top box having first circuitry configured to control a display device, second circuitry configured to communicate with a remote control, a housing sized to contain the first and second circuitry, and an input device that may be actuated by a user to send a wireless signal to the remote control. In some implementations, the wireless signal may cause the remote control to emit a notification (e.g., a buzzing, a sound, a light) that is detectable by a user, which may aid a user searching for the remote control.

Some embodiments include a set-top box having a feature shaped to hook or otherwise engage with a display device. In some cases, a force generated between an adjustable grip and such a feature may be sufficient that the set-top box may “grip” the display device.

Certain embodiments may include a set-top box including first circuitry configured to control a display of information on the display device, a housing sized to contain the first circuitry, and one or more features coupled to the housing (or integrated as part of the housing). The features may be shaped to provide for hanging the set-top box on a surface or edge (e.g., the top surface) of a display device.

Some embodiments may include a set-top box having circuitry that includes a computer readable storage medium and a processor coupled to the computer readable storage medium. The processor may be configured to execute an executable instruction set stored on the computer readable storage medium. The executable instruction set may cause the set-top box to notify a user of the display device that a product or service associated with the displayed information is available for purchase, receive an input indicating a desire to purchase the product or service, and initiate a transaction associated with a purchase of the desired product or service. Displayed information may be media information, a song, television show, sports event, movie, video and the like. Displayed information may also include metadata and/or other descriptors. A desired product or service may include a product or service associated with the content (or topic) of the displayed information, such as a watch worn by a character in a television show, a car shown in a photograph, a musical instrument used to make a certain sound, and the like. In some embodiments, related products or services (e.g., products or services similar to those displayed) may be identified and displayed. For example, a user watching a James Bond movie may identify a car, which causes the display of (e.g.) all cars used by James Bond in various James Bond movies.

Certain embodiments include a camera, which may be a digital camera. The camera may acquire photographs and/or movies, and in some cases may be oriented facing a user of a display device, such that the user's image may be recorded. In some cases, the camera may be coupled to control circuitry and/or software, such that input from the camera (e.g., a user's gestures) may be used to control the set-top box and/or the display device. Certain embodiments may include two or more cameras, which may be oriented toward the same or different fields of view.

In some embodiments, a plurality of cameras image the same region, each capturing an image from a different angle, such that a “stereographic” image may be obtained. In some cases, resolution of a distance from the cameras may be improved using such combinations of cameras.

### BRIEF DESCRIPTION OF THE DRAWINGS

FIG. 1 is a diagrammatic representation of a media system, according to certain embodiments.

FIG. 2 is a schematic illustration of various components of a set-top box, according to certain embodiments.

FIGS. 3A and 3B show two different views of a set-top box, according to some embodiments.

FIGS. 4A, 4B, and 4C illustrate different views of a set-top box according to certain embodiments.

FIG. 5 illustrates a perspective view of a set-top box, according to some embodiments.

FIGS. 6A and 6B show a set-top box in two exemplary configurations.

FIGS. 7A-F illustrate various configurations of an adjustable grip, according to certain embodiments.

FIG. 8A is a diagrammatic representation of a set-top box according to certain embodiments.

FIG. 8B is a diagrammatic representation of a set-top box according to certain embodiments.

### DETAILED DESCRIPTION OF THE INVENTION

Various embodiments include a set-top box that may be configured to mount atop, or attach to, a “thin” display device, such as a plasma display, LCD display, OLED display, projection display, and the like. The nomenclature “set-top” is chosen for convenience, and is not intended to limit to a particular type of display device (e.g., a television set) or application (e.g., television).

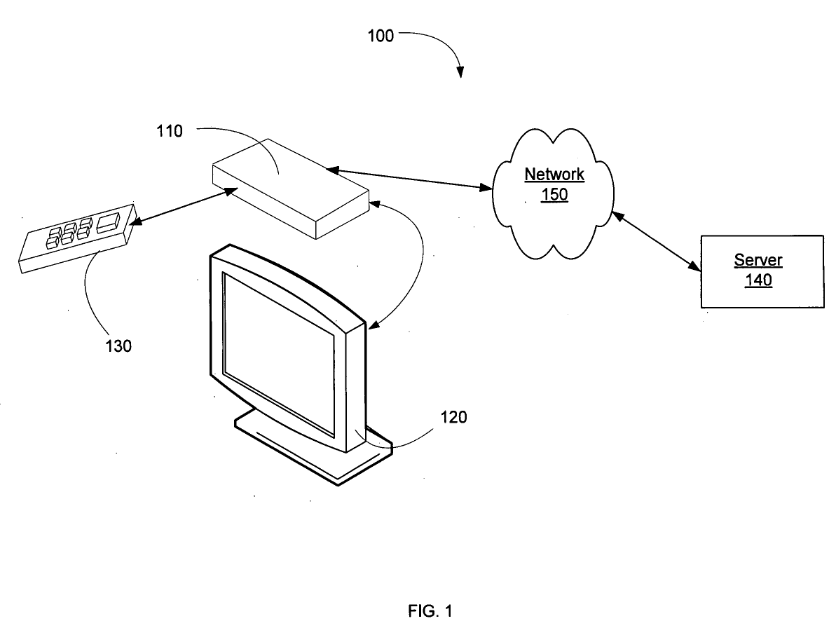

FIG. 1 is a diagrammatic representation of a media system, according to certain embodiments. Media system 100 includes a set-top box 110 configured to control a display device 120. Display device 120 may include a video display and/or an audio output (e.g., a speaker or headphone jack). Display device 120 may include a flat panel display, a projection display, a cathode ray tube, a liquid crystal display, a plasma display, an OLED display, or another type of display device. Set-top box 110 and display device 120 are communicatively connected, and may communicate, for example, via electrical (e.g., S-video, HDMI), optical, and/or wireless (e.g., wireless HDMI, 802.*) connections.

A user may control set-top box 110 to choose and display media on display device 120. In some embodiments, set-top box 110 may be controlled using remote 130. Remote 130 communicates with set-top box 110 (e.g., by transmitting a signal), often in response to receiving input from the user. Set-top box 110 may also transmit a signal to remote 130. In some embodiments, remote 130 is physically separated from set-top box 110, and may generally communicate wirelessly with set-top box 110 using one or more optical (e.g., infrared) and/or radio frequency (e.g., 802.*) communications protocols. In other embodiments, remote 130 is physically integrated with set-top box 110.

Some embodiments of set-top box 110 include a sensor or other input device (e.g., a button, trackball, touch screen and the like). In some cases, an input device may be operated by a user to cause remote 130 to emit a signal whereby the remote control may be located. Appropriate signals include audible (e.g., an alarm), vibratory (e.g., “buzzing”), and/or visible (e.g., a blinking LED) signals.

Some embodiments of set-top box 110 provide for the receipt of physical memory devices (e.g., discs, memory cards, memory sticks and the like) and/or circuitry to connect to storage devices (e.g., a USB, USB2, optical, and/or Firewire port). In some applications, such devices may include media (e.g., movies, songs, TV shows) and/or media information (e.g., titles, times, genres, and the like).

Generally, the use of set-top box 110 includes display of media and associated information (e.g., a title, episode, date of release) on display device 120. Information associated with the subject of an item of media may also be displayed, such as an actor in a movie, a car in an advertisement, or a name of a sports team. Operation of set-top box 110 may include the receipt of input from a user (e.g., via remote 130), and the display of further information (e.g., more or less detailed information, or different information). Information may be associated with one or more items of media content, and various embodiments allow a user to identify and play one or more items of media content.

Remote 130 is typically configured to allow a user to select information, parameters, items of content, and the like. Remote 130 may include various buttons, trackballs, accelerometers, motion and/or position sensors and circuitry, feedback/actuation components, and other circuitry as needed to provide for an interface between a user and various components of media system 100. In some embodiments, remote 130 includes a port to receive a physical storage device (e.g., a disc, memory card, and the like). Remote 130 may include a telephone.

In some implementations, set-top box 110 includes a storage device, which stores at least a portion of one or more items of content for display on display device 120. In some configurations, items of content and/or associated information are stored on a server 140, which may be communicatively connected to set-top box 110 via a network 150. Network 150 may include the Internet. Network 150 may be a wide area network (WAN), a local area network (LAN), intranet, extranet, private network or other network, as well as a combination of these networks.

Network 150 may include one or more wireless networks, including various 802.11, 802.16, GSM and/or CDMA networks. In some configurations, set-top box 110 communicates with server 140 using a standard internet protocol (IP), and may use one or more IP addresses. In some cases, communications may include encrypted information.

In some embodiments, server 140 may be integrated with set-top box 110. In such cases, network 150 may also include various wired interfaces such as a communications bus.

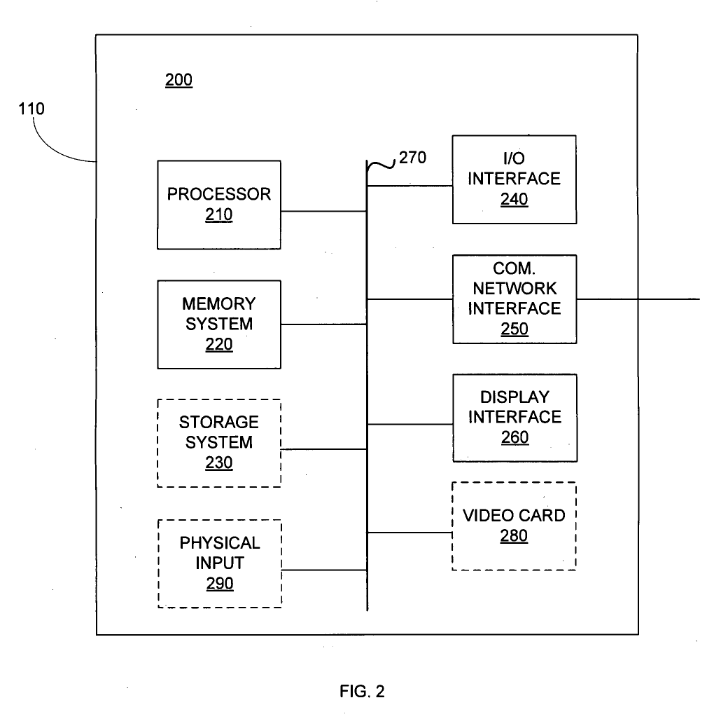

FIG. 2 is a schematic illustration of exemplary components of a set-top box, according to certain embodiments. Set-top box 110 generally includes a housing 200, which may be sized to contain the various components of set-top box 110. In some embodiments, housing 200 is characterized by a depth in a first dimension that is approximately parallel to the viewing direction associated with a display device controlled by set-top box 110. Typically, this dimension is smaller than a “width” of set-top box 110 (which may be associated with a width of the display device being controlled by set-top box 110). In some embodiments set-top box 110 may have a depth of less than eight inches, less than four inches, or even less than two inches. In some embodiments, set-top box 110 has a “height” in a vertical dimension of less than three, two, or even one inch.

In exemplary embodiments, set-top box 110 includes processor 210, memory system 220, optional storage system 230, input/output (I/O) interface 240, communication network interface 250, and display interface 260. These components may be generally connected via a system bus 270. In some embodiments (e.g., depending upon hardware included within display device 120 (FIG. 1)), set-top box 110 may include video card 280.

Set-top box 110 may also include a physical input device 290, which may include a sensor (e.g., a button) or other component that may be physically actuated (e.g., by a user).

Processor 210 may be configured to execute instructions. In some embodiments, processor 210 comprises integrated circuits or any processor capable of processing the executable instructions. In some embodiments, processor 210 may include a cache, a multi-core processor, a video processor, and/or other processors.

Memory system 220 may be any memory configured to store data. An example of memory system 220 includes a computer readable storage medium, which may include any medium configured to store executable instructions. For example, the memory system 220 may include, but is not limited to, storage devices such as RAM, ROM, flash memory, and/or other storage devices.

Certain configurations include storage system 230 as part of set-top box 110. In other configurations, storage system 230 may be implemented remotely, for example as part of server 140. Storage system 230 may be any storage configured to receive, store, and provide data. Storage system 230 may also include computer readable storage media such as flash memory, a hard drive, an optical drive, and/or magnetic tape. Storage system 230 may include a database or other data structure configured to hold and organize data. In some embodiments, set-top box 110 includes memory system 220 in the form of RAM and storage system 230 in the form of flash memory.

I/O interface 240 may include hardware and/or software to interface with various devices such as remote 130, a keyboard, touchscreen, keypad, mouse, printer, scanner, or other I/O device. I/O interface 240 may receive information from a device and/or transmit information to the device.

Communication network interface 250 may communicate with various other devices, and such communications may include the use of network 150 (FIG. 1). Communication network interface 250 may support serial, parallel, USB, firewire, ethernet, and/or ATA communications. Communication network interface 250 may also support 802.11, 802.16, GSM, CDMA, EDGE and various other wireless communications protocols.

Display interface 260 may include any circuitry used to control and/or communicate with a display device, such as display device 120. In some configurations, display interface 260 includes a video card and memory. In some configurations, display device 120 (FIG. 1) may include a video card, and display interface 260 may communicate with the video card of display device 120.

The functionality of various components may include the use of executable instructions, which may be stored in memory and/or computer readable storage media. In some embodiments, executable instructions may be stored in memory system 220 and/or storage system 230. Executable instructions may be retrieved and executed by processor 210, and may include software, firmware, and/or program code. Executable instructions may be executed by the processor to perform one or more methods.

Storage system 230 and/or memory system 220 may be configured to store one or more items of content (e.g., media), such as a song, video, television program, movie, web page, video, blog, and the like. An item of content may generally include or be associated with information or metadata that characterize the item. Such information may include data associated with an item's title, artist, publisher, genre, subject matter, release date and the like. Information may generally include any characteristic of an item of content.

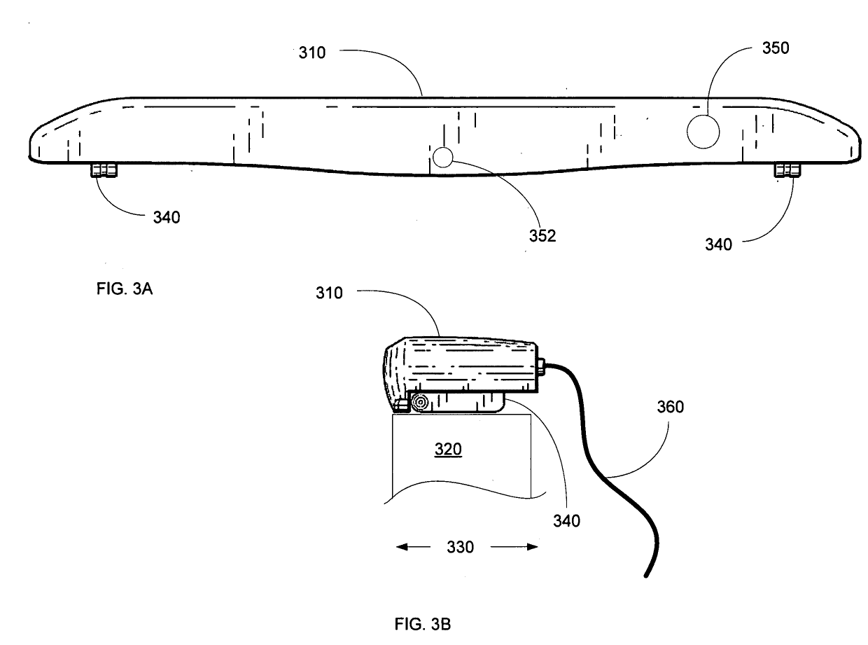

FIGS. 3A and 3B show two different views of a set-top box, according to some embodiments. FIG. 3A illustrates a “front” view of set-top box 310. For the purposes of this description, “front” refers to a face that may be presented to a viewer of a display device controlled by the set-top box. FIG. 3A illustrates a location for an optional input device 350, which may include a button. FIG. 3A also shows a view of two adjustable grips 340. A set-top box may have any number of adjustable grips 340, although one, two or three adjustable grips may be typical.

Some embodiments of set-top box 110 may include a camera, which may be a digital camera configured to take still and/or moving images. FIG. 3A illustrates an optional camera 352, which may be oriented such that it captures images associated with the front of a controlled display device. In certain embodiments, a user's image is captured by the camera. In some embodiments, one, two or even more cameras may be used to acquire images associated with a user's gestures and/or motions. In some cases, circuitry and associated software may be combined with these images such that a user's gestures are interpreted as commands.

FIG. 3B illustrates a side view of set-top box 310. In this illustration, set-top box 310 is shown disposed on top of a display device 320. Display device 320 may be characterized by a depth 330 in direction parallel to a viewing direction. In some embodiments, this depth may be less than 10 inches, less than 5 inches, or even less than 3 inches. Set-top box 310 may be characterized by a “depth” of similar proportions, as shown in FIG. 3A.

In some embodiments, set-top box 310 includes a motherboard upon which various components are mounted. In one embodiment, the motherboard is designed to minimize the depth of the set-top box, such that the final depth of the set-top box is below six inches, and preferably below three inches. In some cases, set-top box 310 may be less than one inch deep.

FIG. 3B also illustrates a side view adjustable grip 340. In this configuration, adjustable grip 340 has been adjusted so that it acts as a “foot” for set-top box 310. A “foot” configuration may provide for stably positioning set-top box 310 on a flat surface having a depth comparable to (or greater than) set-top box 310. A surface of an adjustable grip and/or a set-top box may incorporate a soft material (e.g., rubber) that may also enhance friction and improve gripping of the display device.

FIG. 3B also illustrates a cord 360. Exemplary cords include power cords, communication cords, cables, and the like. Some cords may exert a force on set-top box 310 (e.g., due to a cord hanging on the box), which may act to de-stabilize set-top box 310. In some cases, an adjustable grip may be used to counteract a force exerted by the cord. Sometimes, depth 330 is sufficiently large that set-top box 310 sits stably atop display device 320 (e.g., as in FIG. 3B). In other cases, adjustable grips 340 may be extended to stabilize set-top box 310 against various forces.

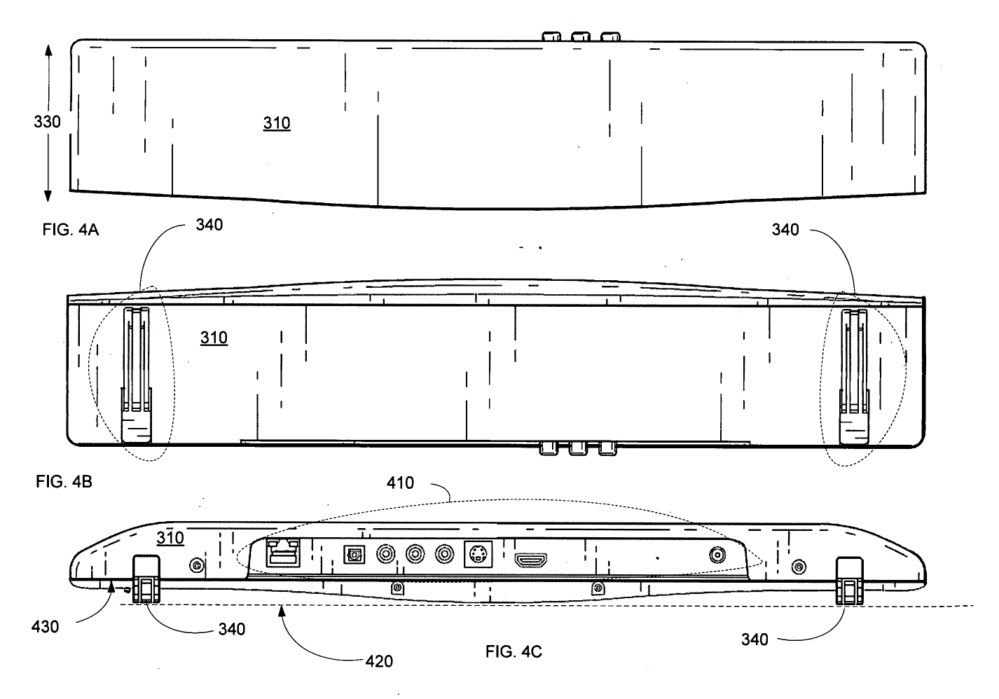

FIGS. 4A, 4B, and 4C illustrate different views of a set-top box according to certain embodiments. FIG. 4A illustrates a “top” view of set-top box 310, and further illustrates depth 330.

FIG. 4B illustrates a “bottom” view of set-top box 310, and illustrates two adjustable grips 340, disposed near the edges of set-top box 310. In some cases, the width between two adjustable grips 340 may be adjustable. Some embodiments include a single adjustable grip; other embodiments include three, six, or even eight adjustable grips.

FIG. 4C illustrates a “back” view of set-top box 310, and illustrates several exemplary input/output ports 410, which are generally connected to appropriate circuitry within. Exemplary ports may include ethernet, USB, S-video, HDMI, firewire, RGB, coaxial, cable, mini-USB and the like, as well as ports configured to receive a storage device such as a memory card, smart card, flash drive, hard drive and the like.

FIG. 4C illustrates two adjustable grips 340, configured to form two “feet” sharing a common plane 420. Set-top box 310 may also include a bottom surface 430, which may be substantially flat in certain embodiments.

Certain embodiments of set-top box 310 include a battery or other energy-storage device, which may provide full-service power or backup power.

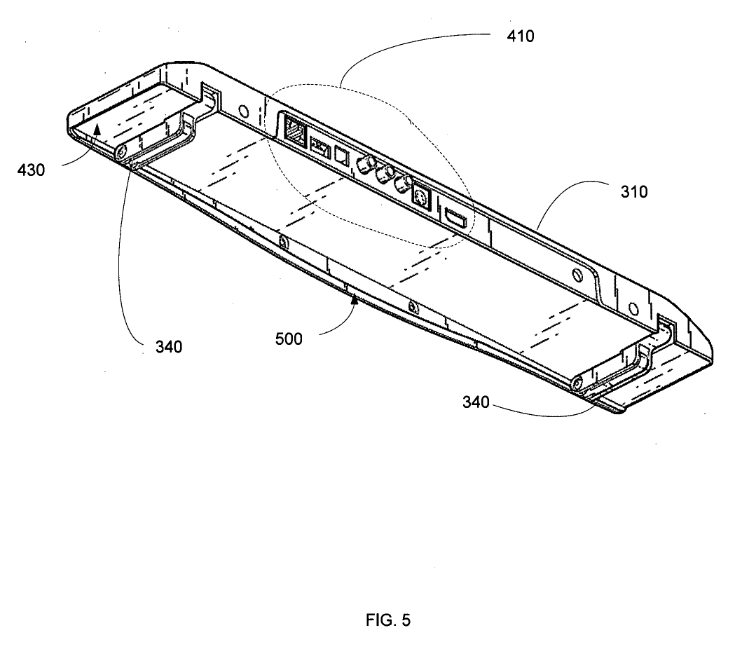

FIG. 5 illustrates a perspective view of a set-top box, according to some embodiments. FIG. 5 illustrates a feature 500 that may act as a “lip” or “hook” and exert a force that helps stabilize set-top box 310 attached to a display device in some configurations. In this example, feature 500 includes a long “lip” associated with the front of set-top box 310, which (in this example) extends below bottom surface 430.

Typically, feature 500 may physically couple with a display device without blocking displayed information. In some embodiments, adjustable grips 340 are configured to apply a first force to the display device (e.g., a “frontward” force), and feature 500 resists this force with an opposite force (e.g., a “backward” force). As such, feature 500 may be combined with adjustable grips 340 to firmly grip or hold set-top box 310. In some cases, this grip may be strong enough to suspend set-top box 310 below a gripped display device. In other cases, this grip may be strong enough to firmly support set-top box 310 atop a gripped display device.

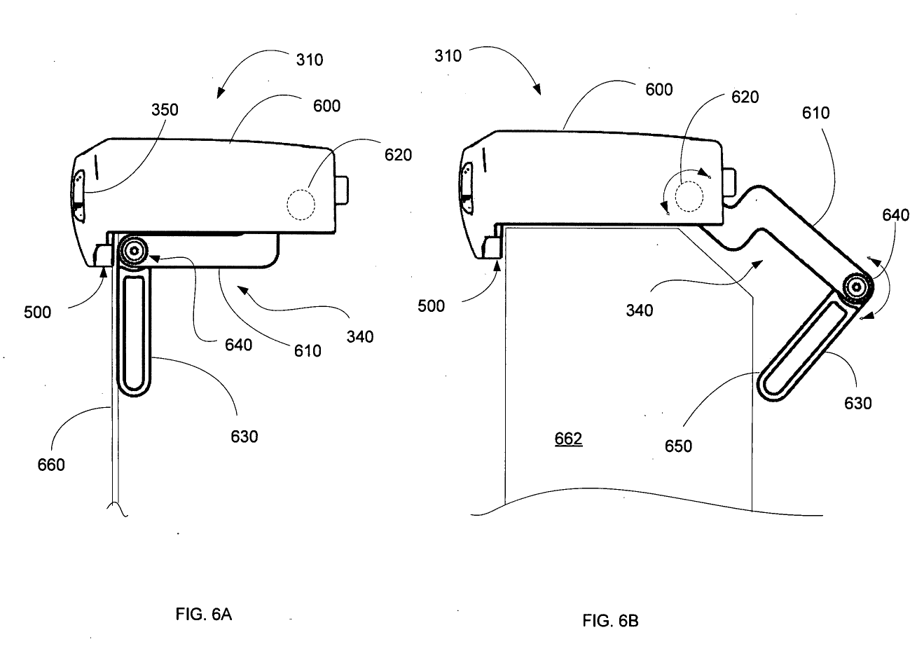

FIGS. 6A and 6B show a set-top box in two exemplary configurations. Typically, a set-top box may be adjusted and/or adapted to a variety of display devices. The configurations described herein illustrate adaption of a set-top box to various display devices, are for illustrative purposes only, and not intended to be limiting.

At least some of the adjustability of a set-top box may result from configuring one or more adjustable grips 340. FIGS. 6A and 6B show exemplary configurations of an adjustable grip 340. In this example, each adjustable grip 340 includes a first arm 610 attached to housing 600 via a hinge 620. Second arm 630 is attached to first arm 610 via hinge 640.

In FIG. 6A, set-top box 310 is configured to sit atop display device 660. In FIG. 6B, set-top box 310 is configured to sit atop display device 662. Display device 660 may be less than one inch, ½ inch, or even ¼ inch thick. In FIG. 6A, adjustable grip 340 is configured such that second arm 630 is parallel to a surface of display device 660 with which it is in contact. Such a configuration may provide for the application of a gripping force to a relatively large area of a display device housing (e.g., the contact area between second arm 630 and display device 660).

FIG. 6B illustrates an adjustable grip 340 adapted to attach set-top box 310 to display device 662. Display device 662 is thicker than display device 660, and may be two, four, or even six inches deep. In this example, a smaller portion (i.e., the curved end) of second arm 630 makes contact with display device 662.

In some implementations, it may be advantageous to apply a surface treatment 650 to an arm, which may increase or decrease friction between the arm and the display device gripped by the arm. A rubber layer, neoprene, or a roughened surface may increase friction. A smoother surface or a low-friction layer such as PTFE may decrease friction.

In some embodiments, an adjustable grip may include a spring, which may apply a force that causes the adjustable grip to “grip” a display device. In some cases, a “grip” includes a first force applied by an adjustable grip, counteracted by a second force applied by a feature (e.g., feature 500) against which the adjustable grip “grips.” In such cases, a display device may be “squeezed” between an adjustable grip and opposable feature. Feature 500 may include a surface treatment to improve grip.

Some embodiments may include an adjustable grip comprising a flexible arm. Compliance or flexing of the arm may provide for adjustability of the grip.

In some embodiments, components such as housings and arms are comprised of lightweight materials, including plastics such as polycarbonate, PET, PETE, polyethylene, polypropylene and composites thereof. In some cases, electrical shielding may be incorporated to reduce electromagnetic interference.

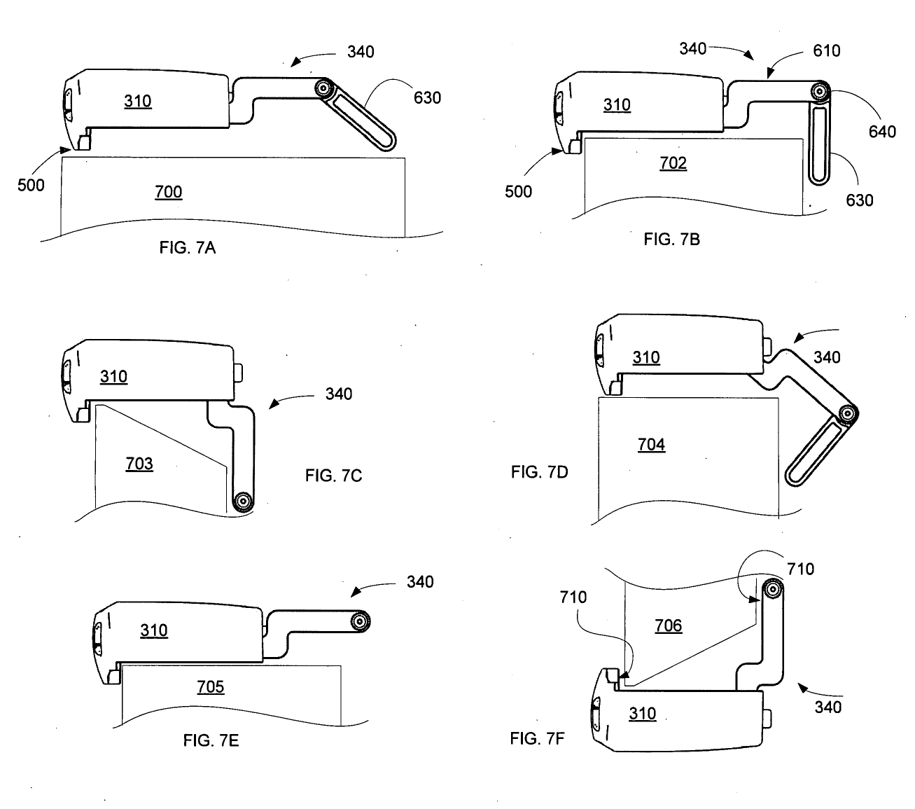

FIGS. 7A-F illustrate various configurations of an adjustable grip, according to certain embodiments. An adjustable grip may be adjusted and/or adapted to a variety of display devices, and generally provides for the attachment to (e.g., gripping, sitting upon, or other physical engagement with) a display device.

In FIG. 7A, set-top box 310 is mounted atop display device 700. Adjustable grip 340 is configured such that a portion of second arm 630 is coplanar with a bottom edge of feature 500, which may provide for a stable position atop a relatively deep display device such as display device 700.

In FIG. 7B, set-top box 310 is mounted atop display device 702. In this configuration, hinge 640 is operated to adjust the angle between first arm 610 and second arm 630 so that second arm 630 may apply a horizontal force to a side of display device 702. In some cases, this horizontal force may be opposed and/or complemented by a force exerted by feature 500. Such a combination of forces may allow adjustable grip 340 to “grip” a display device.

In some cases, an adjustable grip may include a spring that may at least partially allow the adjustable grip to “grip” the display device. In some cases, an adjustable grip may include a flexible arm. Elastic deformation of the flexible arm may cause a “gripping” force whereby the adjustable grip may “grip” a display device.

In certain embodiments, a hinge may include a frictional force that resists rotation of the hinge. Typically this frictional force may be small enough that a user may overcome the frictional force when adapting the adjustable grip to a display device. The frictional force may be large enough that an adjustable grip that has been adapted to fit a display device firmly “grips” the display device after adjustment. In some cases, the frictional force may be adjusted (e.g., by tightening a nut associated with a hinge). Some arms and/or hinges may have a locking mechanism that locks the adjustable grip in a desired configuration.

In FIG. 7C, set-top box 310 is mounted atop display device 703. In this configuration, second arm 630 is folded “inside” first arm 610 via hinge 640, and first arm 610 contacts display device 703. FIG. 7C also illustrates how a combination of adjustable grip 340 and feature 500 may be used to attach, seat, or otherwise dispose a set-top box 310 atop a display device that does not have a large or flat top surface, such as display device 703.

In FIG. 7D, set-top box 310 is mounted atop display device 704, illustrating another configuration of adjustable grip 340.

In FIG. 7E, set-top box 310 is mounted atop display device 705. In this configuration, adjustable grip 340 is positioned such that its length substantially horizontal, which may provide support another object (e.g., another piece of electronic equipment) on top of set-top box 310. In some embodiments, adjustable grips may be configured to form a “shelf” upon which other items may be placed.

Adjustable grips attached to the same set-top box may be disposed in different configurations. For example, a first adjustable grip may be used to stabilize a set top box atop a display device, and a second adjustable grip may be used to form a platform upon which another component may sit. In some cases, one or more adjustable grips may form a “shelf” upon which an object may sit. In certain configurations, a first adjustable grip serves to attach a set-top box to a display device, and a second adjustable grip serves to hold another device.

In FIG. 7F, set-top box 310 is mounted below display device 706. In this configuration, adjustable grips 340 may grip strongly enough that set-top box 310 may stably “hang” beneath display device 706. In some configurations, gripping may be enhanced by a high friction surface at one or more contact points between a set-top box and the display device. In FIG. 7F, such a surface is illustrated as surfaces 710. In some configurations a set-top box 310 may engage with a feature (e.g., a ledge or lip) on display device 706.

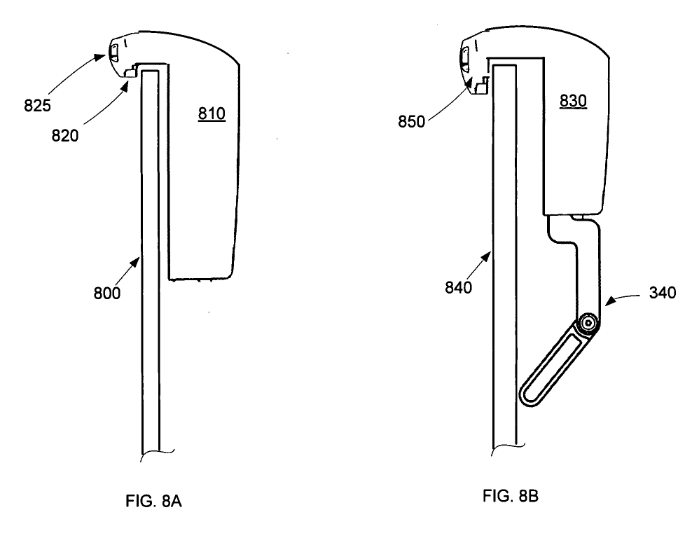

FIG. 8A is a diagrammatic representation of a set-top box according to certain embodiments. FIG. 8A illustrates set-top box 810, which may be shaped to “hang” on a surface or “edge” of a thin display device 800. Such embodiments may be particularly useful with display devices such as those based on OLED displays, which may be less than 1 inch, 0.5 inches, or even 0.25 inches thick.

Hanging may be enhanced by designing a housing that orients components in a direction that minimizes a thickness of the set-top box in the viewing direction. For example, a motherboard and/or other cards or chips may be mounted vertically (e.g., with their flat surfaces parallel to the viewing direction). A feature such as feature 820 may also be shaped such that set-top box 810 may “hook” the top surface or edge of display device 800.

In some embodiments, the housing may be shaped such that substantially most of the set-top box is disposed “behind” the display device. Such embodiments may vary, depending upon the requirements of the communication links (e.g., to remote 130). For communications requiring “line of sight” between a remote and a set-top box, a small sensor 825 may be disposed at the top/front surface of the set-top box to transmit or receive communication signals.

FIG. 8B is a diagrammatic representation of a set-top box according to certain embodiments. Set-top box 830 includes a feature 850 which is shaped to provide for hanging set-top box 830 on a surface or edge of a display device, such as display device 840. In some embodiments, an adjustable grip 340 may be used to provide stability and/or allow adaptability of set-top box 830 to display devices having different thicknesses (e.g., between 0.2 and 3 inches thick).

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A set-top box for controlling a display device, the set-top box comprising:
first circuitry configured to control a display of information on the display device;
a housing sized to contain the first circuitry; and
one or more adjustable grips attached to the housing, the one or more adjustable grips adaptable to removably attach the set-top box to the display device.

2. The set-top box of claim 1, wherein the one or more adjustable grips may be adjusted to exert a force against a side of the display device.

3. The set top box of claim 2, wherein removably attached includes disposing the set-top box atop the display device.

4. The set-top box of claim 1, wherein any of the one or more adjustable grips includes at least one hinge.

5. The set-top box of claim 4, wherein the hinge incorporates a friction force that resists operation of the hinge and is large enough to at least partially provide for the removable attachment.

6. The set-top box of claim 4, wherein the hinge includes a mechanism that provides for adjusting a friction force associated with an operation of the hinge.

7. The set-top box of claim 1, wherein any of the one or more adjustable grips includes one or more arms.

8. The set-top box of claim 7, wherein any of the one or more arms is flexible.

9. The set-top box of claim 8, wherein a flexing of the flexible arm induces a force that at least partially provides for the removable attachment.

10. The set-top box of claim 1, wherein any of the one or more adjustable grips includes a spring.

11. The set-top box of claim 1, wherein any of the one or more adjustable grips includes an actuator.

12. The set-top box of claim 11, wherein the actuator includes an electromagnetic actuator.

13. The set-top box of claim 1, wherein the housing is characterized by a depth in a viewing direction associated with the display device, and the depth is between 0.5 and 8 inches.

14. The set-top box of claim 13, wherein the depth is between 1 and 3 inches.

15. The set-top box of claim 1, further comprising second circuitry contained within the housing and configured to communicate with a remote control.

16. The set-top box of claim 15, further comprising an input device that may be actuated by a user to send a wireless signal to the remote control that causes the remote control to emit a notification that is detectable by the user.

17. The set-top box of claim 16, wherein the notification includes an audible notification.

18. The set-top box of claim 16, wherein the notification includes a visual notification.

19. The set-top box of claim 16, wherein the notification includes a vibratory notification.

20. The set-top box of claim 1, wherein the housing includes one or more features shaped to oppose a force exerted by an adjustable grip during attachment.

21. The set-top box of claim 1, further comprising a storage device configured to store media information.

22. The set-top box of claim 1, wherein the first circuitry is configured to:
receive one or more items of media;
display information associated with the received items;
receive a choice from a user that identifies a chosen item of media; and
play the chosen item of media on the display device.

23. The set-top box of claim 1, further comprising a processor in communication with the first circuitry and configured to perform a method that includes:
displaying purchase information associated with a product or service displayed on the display device;
receiving a command to purchase the displayed product or service; and
initiating a transaction to purchase the displayed product or service.

24. A set-top box for controlling a display device, the set-top box comprising:
first circuitry configured to display media information on the display device;
second circuitry configured to communicate with a remote control;
a housing sized to contain the first and second circuitry; and
one or more adjustable grips attached to the housing, each adjustable grip comprising:
a first arm;
a first hinge connecting a first end of the first arm to the housing;
a second arm; and
a second hinge connecting a second end of the first arm to a first end of the second arm;
wherein the adjustable grips may be adapted to removably attach the set-top box to the display device.

25. A set-top box for controlling a display device, the set-top box comprising:
first circuitry configured to control a display of information on the display device;
second circuitry configured to communicate with a remote control;
a housing sized to contain the first and second circuitry; and
an input device that may be actuated by a user to send a wireless signal to the remote control that causes the remote control to emit a notification that is detectable by the user.

26. A set-top box for controlling a display device, the set-top box comprising:
first circuitry configured to control a display of information on the display device;
a housing sized to contain the first circuitry; and
one or more features coupled to the housing, the features shaped to provide for hanging the set-top box on a surface or edge of the display device.

27. The set-top box of claim 26, wherein the display device has a depth of less than four inches.

28. A set-top box for controlling a display device, the set-top box comprising:
first circuitry configured to control a display of information on the display device;
second circuitry including a computer readable storage medium and a processor coupled to the computer readable storage medium, the processor configured to execute an executable instruction set stored on the computer readable storage medium, the instruction set executable by the processor to perform a method comprising:
providing a notification that a product or service associated with the displayed information is available for purchase; and
initiating a transaction associated with a purchase of the product or service.

29. The set-top box of claim 28, wherein the method further comprises receiving an input indicating a desire to purchase the product or service.

30. The set-top box of claim 28, wherein the notification is provided on the display device.

31. The set-top box of claim 28, wherein the transaction includes a provider of financial credit.

32. The set-top box of claim 28, wherein the information includes any of a movie, television show, sports event, song, and video.

33. The set-top box of claim 28, wherein the product or service is associated with a topic of the displayed information.

34. The set-top box of claim 28, wherein the product or service is displayed on the display device before the transaction is initiated.

35. A set-top box for controlling a display device, the set-top box comprising:
first circuitry configured to control a display of information on the display device; and
one or more cameras coupled to the first circuitry.
